(19) United States
(12) Patent Application Publication
(10) Pub. No.: US 2026/0252622 A1
(43) Pub. Date: Aug. 27, 2026

(54) IMPLICIT DATA STORAGE AND RETRIEVAL VIA HOPFIELD ENCODING NETWORKS

(71) Applicant: INTERNATIONAL BUSINESS MACHINES CORPORATION, ARMONK, NY (US)

(72) Inventors: Satyananda Kashyap, San Jose, CA (US); Dmitry Krotov, Cambridge, MA (US); Tanveer F. Syeda-Mahmood, Cupertino, CA (US)

(21) Appl. No.: 19/064,182

(22) Filed: Feb. 26, 2025

(51) Int. Cl. G06F 16/532; G06F 16/25

(52) U.S. Cl. CPC G06F 16/532; G06F 16/258

(57) ABSTRACT

According to one embodiment, a method, computer system, and computer program product for implicit data storage and retrieval using a Hopfield encoding network (HEN) is provided. The present invention may include training a Modern Hopfield network (MHN) using one or more image datasets; upon receiving a partial query for a complete image, processing the partial query through an image encoder to transform the partial query into a latent space neural encoded representation; processing the latent space neural encoded representation through the trained MHN as a retrieval cue to iteratively update the latent space neural encoded representation until a corresponding comprehensive latent space neural encoded representation is formed; and processing the corresponding comprehensive latent space neural encoded representation through an image decoder to generate the complete image.

### STATEMENT REGARDING PRIOR DISCLOSURES BY THE INVENTOR OR A JOINT INVENTOR

The following disclosure is submitted under 35 U.S.C. § 102 (b)(1)(A):
DISCLOSURE: “Modern Hopfield Networks meet Encoded Neural Representations-Addressing Practical Considerations”, Satyananda Kashyap, Niharika S. D'Souza, Luyao Shi, Ken C. L. Wong, Hongzhi Wang, and Tanveer Syeda-Mahmood, Sep. 24, 2024, The Thirty-Eighth Annual Conference on Neural Information Processing Systems (NeurIPS 2024) [workshop paper], pp. 1-17.

### BACKGROUND

The present invention relates, generally, to the field of computing, particularly, to data storage and retrieval, and more particularly, to data storage and retrieval using recurrent neural networks.

A recurrent neural network (RNN) is a deep neural network that is trained to make sequential predictions or conclusions based on sequential inputs. An RNN can make predictions/conclusions based on a maintained internal state, i.e., memorized patterns. A Hopfield network, also known as an associative memory, is a type of RNN that, through rule-based learning, can store data, i.e., input patterns, as fixed-point attractor states in an energy landscape, and can retrieve the stored data using recall patterns from input cues. Thus, Hopfield networks can function as content-addressable memory (CAM).

### SUMMARY

Embodiments of a method, a computer system, and a computer program product for implicit data storage and retrieval using a Hopfield encoding network (HEN) are described. According to one embodiment, a method, computer system, and computer program product for implicit data storage and retrieval using a HEN may include training a Modern Hopfield network (MHN) using one or more image datasets; upon receiving a partial query for a complete image, processing the partial query through an image encoder to transform the partial query into a latent space neural encoded representation; processing the latent space neural encoded representation through the trained MHN as a retrieval cue to iteratively update the latent space neural encoded representation until a corresponding comprehensive latent space neural encoded representation is formed; and processing the corresponding comprehensive latent space neural encoded representation through an image decoder to generate the complete image.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 is an operational flowchart illustrating a Hopfield encoding network data storage and retrieval process according to at least one embodiment.

FIG. 3 depicts a block diagram of the components of a Hopfield encoding network architecture environment according to at least one embodiment.

FIG. 4 is an illustration of a diagram for a Hopfield encoding network data retrieval process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

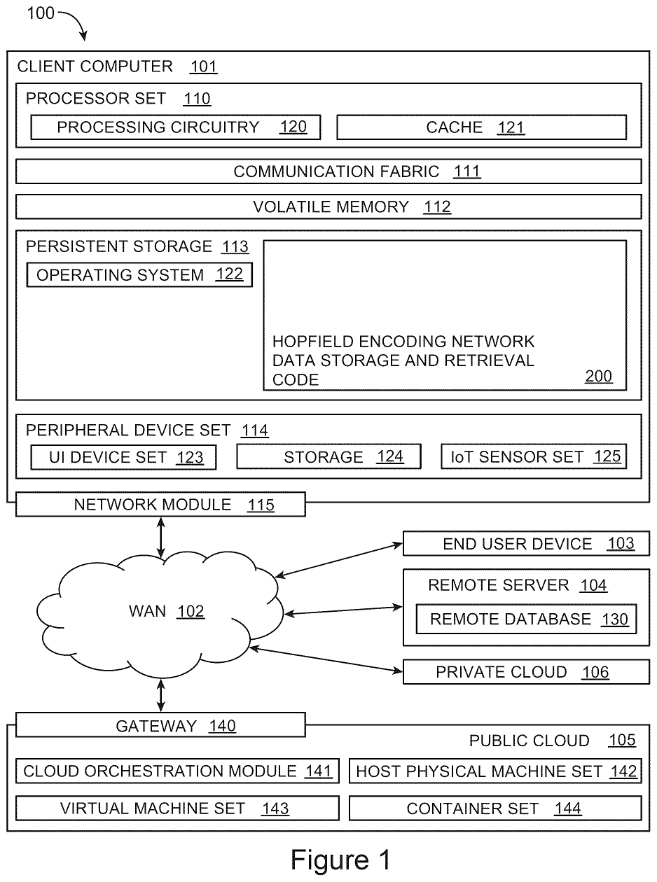

Embodiments of the present invention relate generally to the field of computing, in particular, to data storage and retrieval, and more particularly, to data storage and retrieval using recurrent neural networks (RNNs). The present embodiment has the capacity to improve the storage and retrieval of data by increasing the storage capacity of recurrent neural networks and reducing the occurrence of meta-stable states during the reconstruction of retrieved stored data, respectively. The present embodiment can encode images into a latent space before storing the images and thus, only stores latent space representations of the images. Additionally, encoding the images into a latent space improves the separability of the input patterns, thereby reducing the occurrence of meta-stable states during the reconstruction of the patterns in the trained RNNs. The embodiments mentioned below are further illustrated and described below in the discussions of FIGS. 1, 2, 3, and 4.

Currently, RNNs can serve as content-addressable memories (CAMs) to perform data storage and retrieval. A Classical Hopfield network is a type of RNN architecture that stores memories, i.e., input patterns, as fixed-point attractor states in an energy landscape. Given an input cue, the Classical Hopfield network can retrieve a stored pattern using rule-based learning. However, Classical Hopfield networks are limited by their small storage capacity. A Modern Hopfield network (MHN), a generalization of the Classical Hopfield network, increases the storage capacity of RNNs by implementing a modified energy function that attempts to break the linear scaling relationship between the number of input features and the number of stored memories. However, current frameworks of MHNs face challenges regarding the storage and retrieval of large-scale content. For example, MHNs struggle with the presence of spurious attractors during data reconstruction due to erroneous stored memory patterns stemming from the weak separability of the input patterns. This is especially true when handling large amounts of high-dimensional content, whereby the poor separability of the input patterns results in the occurrence of meta-stable states during the retrieval of the stored memory patterns. Thus, current implementations of MHNs remain limited both in their exponential capacity to store data, i.e., their scalability, and their ability to accurately retrieve the stored data. With the continually increasing demand for storage solutions, it is important that a method exists that enables the storage of data more compactly, and as a result, increases the available storage capacity and more accurately and efficiently retrieves the stored data. Therefore, an implementation of an implicit data storage and retrieval process using a recurrent neural network is needed, in which input data is encoded into a latent space before being stored within the recurrent neural network, and upon recall, the stored input data is retrieved and decoded into its original representational space from its latent space representation.

According to an aspect of the invention, there is provided an implicit data storage and retrieval method using a Hopfield encoding network (HEN) to train a Modern Hopfield network (MHN) using one or more image datasets, thereby generating a trained recurrent neural network (RNN) to perform data storage and data retrieval. Additionally, the present advantage can, upon receiving a partial query for a complete image, process the partial query through an image encoder to transform the partial query into a latent space neural encoded representation, process the latent space neural encoded representation through the trained MHN as a retrieval cue to iteratively update the latent space neural encoded representation until a corresponding comprehensive latent space neural encoded representation is formed, and process the corresponding comprehensive latent space neural encoded representation through an image decoder to generate the complete image. In this embodiment, the present invention has the advantage of using encoded representations of a partial image to query and retrieve a corresponding stored encoded representation of a complete image from the trained RNN. The present invention does not require that all advantages need to be incorporated into every embodiment of the invention.

In embodiments, training a MHN using one or more image datasets comprises processing the one or more image datasets through the image encoder to transform each of the one or more image datasets into comprehensive latent space neural encoded representations, and storing each of the comprehensive latent space neural encoded representations within the MHN to generate the trained MHN. In this embodiment, the present invention has the advantage of improving the separability of the input patterns representing the images, thereby reducing the occurrence of meta-stable states during reconstruction of the patterns, and, as a result, enhancing the accuracy and efficiency of pattern retrieval.

In embodiments, the HEN comprises the trained MHN and a pre-trained autoencoder neural network, whereby the pre-trained autoencoder neural network comprises the image encoder paired to the image decoder. In this embodiment, the present invention has the advantage of providing a framework for implicit data storage and retrieval using RNNs by chaining a trained MHN to both an image encoder and an image decoder.

In embodiments, each of one or more images in the one or more image datasets is stored implicitly within the trained MHN through their comprehensive latent space representations. In this embodiment, the present invention has the advantage of storing only the latent space representations of the images and not the original images, thereby increasing the storage capacity of RNNs.

In embodiments, processing the latent space neural encoded representation through the trained MHN as a retrieval cue to iteratively update the latent space neural encoded representation until a corresponding comprehensive latent space neural encoded representation is formed comprises the trained MHN performing a Hopfield network state update procedure utilizing the latent space neural encoded representation. In this embodiment, the present invention has the advantage of offering a more robust retrieval performance by utilizing encoded representations comprising the most significant features of an image.

In embodiments, an image displaying fifty percent or less of the complete image is used as the partial query. In this embodiment, the present invention has the advantage of requiring less input data to perform a successful image query, thereby decreasing the processing time of the image queries.

In embodiments, the trained MHN converges in sixty iterations or less during the performance of the Hopfield network state update procedure. In this embodiment, the present invention has the advantage of improving the stability of RNNs during data retrieval, thereby optimizing the performance of the trained RNNs.

The present invention may be a system, a method, and/or a computer program product at any possible technical detail level of integration. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, content-addressable memory (CAM), random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The following described exemplary embodiments provide a system, method, and program product to train a Modern Hopfield network (MHN) using one or more image datasets, upon the receipt of a partial query for a complete image, process the partial query through an image encoder to transform the partial query into a latent space neural encoded representation, process the latent space neural encoded representation through the trained MHN as a retrieval cue to iteratively update the latent space neural encoded representation until a corresponding comprehensive latent space neural encoded representation is formed, and process the corresponding comprehensive latent space neural encoded representation through an image decoder to generate the complete image.

Referring to FIG. 1, an exemplary networked computer environment 100 is depicted, according to at least one embodiment. Computing environment 100 contains an example of an environment for the execution of at least some of the computer code involved in performing the inventive methods, such as Hopfield encoding network data storage and retrieval code 200, also referred to as “Hopfield encoding network data storage and retrieval program 200”, or “the program 200”. In addition to code block 200 computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically, at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. Additionally, peripheral device set 114 may comprise sensors, such as fluid sensors, field sensors, etc. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature known as containerization.

PRIVATE CLOUD 106 is similar to public cloud 105, except that the computing resources are only available for use by a single enterprise. While private cloud 106 is depicted as being in communication with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

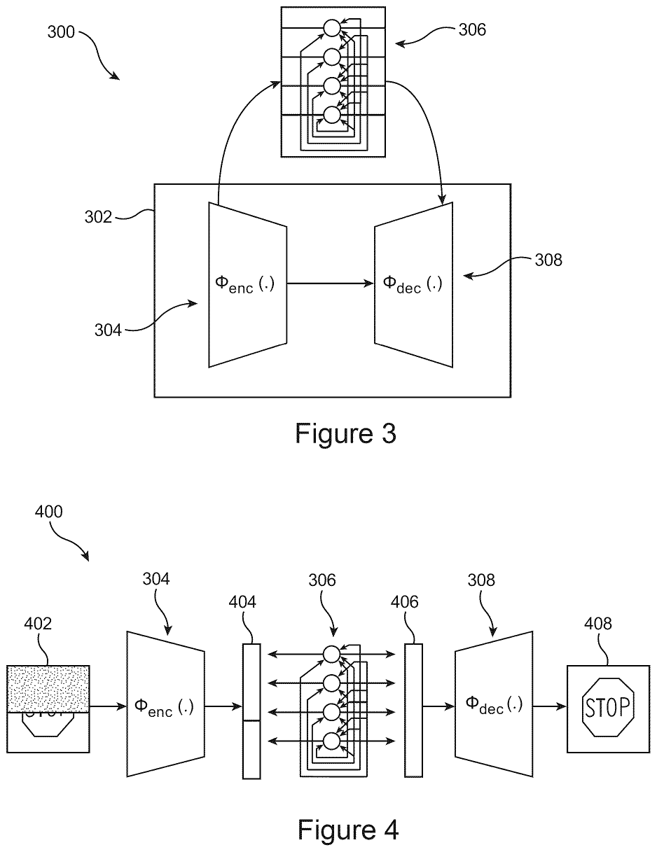

The database 130 may be a digital repository capable of data storage and data retrieval. The database 130 can be present in the remote server 104 and/or any other location in the network 102. The database 130 can comprise image datasets. The datasets can comprise RAW images, for example, of dimensions 256×256, hereinafter referred to as images. The images may be represented in a K-dimensional space. Also, the database 130 may comprise a trained Modern Hopfield network (MHN) 306 (FIG. 3), and a pre-trained autoencoder neural network 302 (FIG. 3), together referred to as a Hopfield Network with Encoded Neural Representations 300 (FIG. 3), and hereinafter referred to as a Hopfield encoding network (HEN) 300. The trained MHN 306 comprises an energy-based system that includes basins of attraction to store and complete patterns. The trained MHN 306 can comprise a memory bank. The memory bank may comprise a weight matrix of comprehensive latent space neural encoded representations, for example, of dimensions m×n×p, whereby the program 200 represents the number of rows as m, the number of columns as n, and the depth dimension, i.e. number of stored comprehensive latent space neural encoded representations, as p.

The pre-trained autoencoder neural network 302 may comprise an encoder-decoder architecture. The pre-trained autoencoder neural network 302 may comprise an image encoder 304 (FIG. 3) paired with an image decoder 308 (FIG. 3). The trained Hopfield network 306 can be chained to both the image encoder 304 and the image decoder 308. The image encoder 304 may be any pre-trained encoder that can transform an image into a latent space representation from its original K-dimensional space representation. The image decoder 308 may be any pre-trained decoder that can transform an image back into its original K-dimensional space representation from its latent space encoded representation.

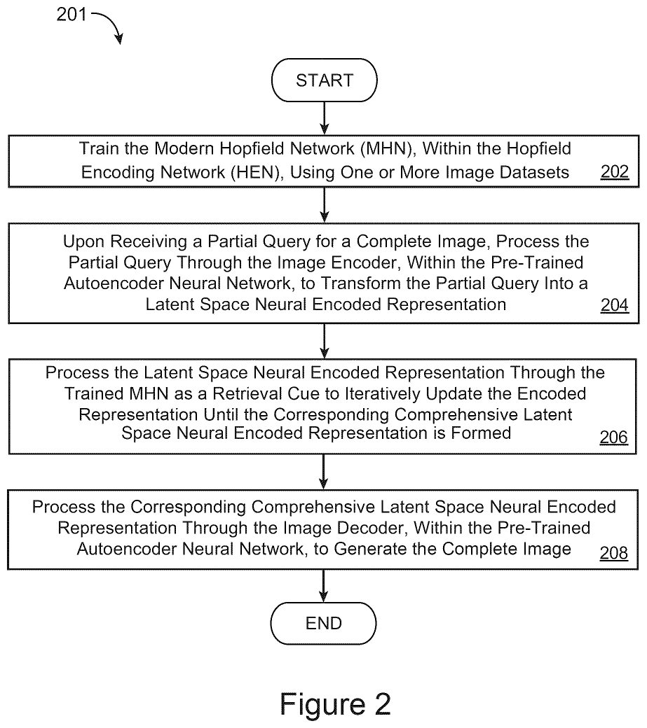

According to the present embodiment, the Hopfield encoding network data storage and retrieval program 200 may be a program capable of training a Modern Hopfield network (MHN) 306 using one or more image datasets. Also, the program 200 may be a program capable of, upon receiving a partial query for a complete image, processing the partial query through an image encoder 304 to transform the partial query into a latent space neural encoded representation. Additionally, the program 200 may be a program capable of processing the latent space neural encoded representation through the trained MHN 306 as a retrieval cue to iteratively update the latent space neural encoded representation until a corresponding comprehensive latent space neural encoded representation is formed. Furthermore, the program 200 may be a program capable of processing the corresponding comprehensive latent space neural encoded representation through an image decoder 308 to generate the complete image. The program 200 may be located on client computing device 101 or remote server 104 or any other device located within network 102. Furthermore, the program 200 may be distributed in its operation over multiple devices, such as client computing device 101 and remote server 104. The Hopfield encoding network data storage and retrieval method is explained in further detail below with respect to FIG. 2.

Referring now to FIG. 2, an operational flowchart illustrating a Hopfield encoding network (HEN) data storage and retrieval process 201 is depicted according to at least one embodiment. At 202, the program 200 trains the Modern Hopfield network (MHN) 306, within the HEN 300, using one or more image datasets. Specifically, the program 200 uses a learning algorithm, such as Hebbian rule-based learning or Storkey rule-based learning, to train the MHN 306 to implicitly store the image data as memories, i.e., specific patterns of neuron activations stored within the weights of the MHN 306. The program 200 may access and retrieve image datasets from the database 130. The program 200 can feed the image datasets into the input layer of the pre-trained autoencoder neural network 302. The pre-trained autoencoder neural network 302 can process the input images from the image datasets, hereinafter referred to as complete images, through the image encoder 304. The image encoder 304 can transform each complete image from a K-dimensional space into a latent space to generate latent space neural encoded representations of each complete image, hereinafter referred to as comprehensive latent space neural encoded representations. A comprehensive latent space neural encoded representation may be a vector, such as a vector of thirty-two (32) elements, a one thousand twenty-four-dimensional (1,024) vector embedding, etc. Mathematically, the image encoding process can be expressed as follows:

\hat{Ξ}=Φ_{enc}(Ξ)

The program 200 may represent a complete image as Ξ. The program 200 may represent the encoder transformation as Φ_{enc}(⋅). The program 200 may represent a comprehensive latent space neural encoded representation as \hat{Ξ}. As a result of encoding the complete images into a latent space, each of the complete images can be represented using input patterns comprising increased separability when compared to the input patterns used to represent the complete images in their original K-dimensional space. As a result, the occurrence of spurious attractor states during the Hopfield network state update process is reduced, as described below in 206, thereby leading to more reliable and efficient retrieval of the stored encoded representations.

The program 200 can store the comprehensive latent space neural encoded representations in a weight matrix within the memory bank of the MHN 306, such that the comprehensive latent space neural encoded representations are capable of being queried and retrieved, as described below in 204, 206, and 208. Storing the comprehensive latent space neural encoded representations as in the described manner enables complete images to be implicitly captured/stored compactly within the trained MHN 306, as opposed to storing the complete images themselves or representations of the complete images in their original K-dimensional space. As a result, the trained MHN 306 comprises increased storage capacity. Training the MHN 306 as in the described manner generates a trained MHN 306 that can process a latent space encoded representation of a partial query to retrieve the corresponding comprehensive latent space encoded representation from the trained MHN 306, as described below in 204, 206, and 208. Additionally, in at least one embodiment, the trained MHN 306 may be optimized using a back propagation technique.

At 204, upon receiving a partial query for a complete image, the program 200 processes the partial query through the image encoder 304, within the pre-trained autoencoder neural network 302, to transform the partial query into a latent space neural encoded representation. The program 200 can receive a partial query for a complete image from an end-user, such as through an end-user device 103. A partial query for a complete image, hereinafter referred to as a partial query, can be in an image format, and can be an image comprising a portion of a corresponding complete image, hereinafter referred to as a partial image, implicitly stored within the trained MHN 306. The partial query may be cued or uncued. In at least one embodiment, a portion representing fifty percent (50%) of a complete image may be used as a partial query. In at least one embodiment, a portion representing less than fifty percent (<50%) of a complete image may be used as a partial query, such as when the most significant features of the corresponding complete image are more easily discernible. The image encoder 304 can transform the partial query from its original K-dimensional space into a latent space, thereby generating a latent space neural encoded representation of the partial query, hereinafter referred to as a latent space neural encoded representation. A latent space neural encoded representation may be a vector, such as a vector of thirty-two (32) elements, a one thousand twenty-four-dimensional (1,024) vector embedding, etc. Mathematically, the partial query encoding process can be expressed as follows:

$${\hat{s}}^{( 0 )} = {Φ}_{enc} ( {s}^{( 0 )} )$$

The program 200 may represent a partial query as s⁽⁰⁾. The program 200 may represent a latent space neural encoded representation as ŝ⁽⁰⁾. The latent space neural encoded representation essentially serves as a partial content address for a corresponding comprehensive latent space neural encoded representation. More specifically, the trained MHN 306 can use a partial content address to perform a Hopfield state update procedure that locates and retrieves the corresponding comprehensive latent space neural encoded representation based on the complete image that is partially displayed as the partial query, as described below in 206.

At 206, the program 200 processes the latent space neural encoded representation through the trained MHN 306, as a retrieval cue, to iteratively update the latent space neural encoded representation until the corresponding comprehensive latent space neural encoded representation is formed. More specifically, when the retrieval cue is fed through the trained MHN 306, the trained MHN 306 performs a Hopfield network state update procedure utilizing the latent space neural encoded representation. The Hopfield network state update procedure comprises iteratively calculating new states based on the existing connections and weights of the trained MHN 306 until the trained MHN 306 reaches a stable configuration, i.e., a convergence state. Starting with the initial state, ŝ⁽⁰⁾, i.e. the latent space neural encoded representation, the iterations, {ŝ^{(t)}}, reconstruct a full pattern, ŝ^{(T}^{_{f}}⁾, that corresponds to one of the stored comprehensive latent space neural encoded representations. In at least one embodiment, the trained MHN 306 may converge in sixty (60) iterations or less. Once the trained MHN 306 reconstructs a full pattern that corresponds to one of the stored comprehensive latent space neural encoded representations, the trained MHN 306 can retrieve the corresponding comprehensive latent space neural encoded representation. Upon retrieval, the trained MHN 306 can output the comprehensive latent space neural encoded representation. Mathematically, the Hopfield network state update procedure can be expressed as a recurrence relation, as follows:

$${\hat{s}}^{( t + 1 )} = softmax ( β {{Φ}_{enc} ( \hat{Ξ} )}^{T} {Φ}_{enc} ( {\hat{s}}^{( t )} ) )$$

The program 200 may represent the temperature parameter as β.

At 208, the program 200 processes the comprehensive latent space neural encoded representation through the image decoder 308 within the pre-trained autoencoder neural network 302 to generate the complete image. More specifically, the image decoder 308 can transform the comprehensive latent space neural encoded representation from its latent space back into its original K-dimensional space. Upon decoding the complete image in its entirety, the HEN 300 can output the generated image in an image format. The program 200 can transmit the generated complete image to the end-user, such as by transmitting the generated complete image to an end-user device 103, public cloud 105, etc. Mathematically, the decoding process can be expressed as follows:

$${s}^{( {T}_{f} )} = {Φ}_{dec} ( {\hat{s}}^{( {T}_{f} )} )$$

The program 200 may represent a retrieved comprehensive latent space neural encoded representation as ŝ^{(T}^{_{f}}⁾, whereby the program 200 represents the final time step at which convergence occurred as T_{f}, for example, sixty (60) iterations. The program 200 may represent the decoder transformation as Φ_{dec}(⋅). The program 200 may represent the generated complete image as s^{(T}^{_{f}}⁾.

Referring now to FIG. 3, a block diagram of the components of a Hopfield encoding network (HEN) architecture environment 300 is depicted, according to at least one embodiment. FIG. 3 may include the pre-trained autoencoder neural network 302, comprising an image encoder 304 paired with an image decoder 308, and a trained Modern Hopfield network (MHN) 306. The trained MHN 306 can be separately chained to both the image encoder 304 and the image decoder 308.

Referring now to FIG. 4, a diagram of a Hopfield encoding network data retrieval process 400 is depicted according to at least one embodiment. In an exemplary implementation embodiment, the process 400 may comprise receiving a partial image as a partial query 402, whereby the partial image displays half of a complete image, such as a portion of a stop sign, and obstructs the other half of the image. The program 200 may process the partial query 402 through the image encoder 304 within the pre-trained autoencoder neural network 302. The image encoder 304 can encode the partial query 402 to generate a latent space neural encoded representation 404. The program 200 can process the latent space neural encoded representation 404 through the trained Modern Hopfield network (MHN) 306 as a retrieval cue to iteratively update the latent space neural encoded representation 404 until a comprehensive latent space neural encoded representation 406 is formed that corresponds to a stored comprehensive latent space neural encoded representation 406 within the trained MHN's 306 memory bank. The program 200 can process the comprehensive latent space neural encoded representation 406 through the image decoder 308 within the pre-trained autoencoder neural network 302. The image decoder 308 can decode the comprehensive latent space neural encoded representation 406 to generate and output the complete image 408, i.e., the complete image of the stop sign.

It may be appreciated that FIGS. 2 through 4 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for implicit data storage and retrieval using a Hopfield encoding network (HEN), the method comprising:
training a Modern Hopfield network (MHN) within the HEN using one or more image datasets;
receiving a partial query for a complete image of a first image, wherein the partial query includes the first image displaying fifty percent or less of the complete image;
processing the partial query through an image encoder to transform the partial query into a latent space neural encoded representation;
processing the latent space neural encoded representation through the MHN as a retrieval cue to iteratively update the latent space neural encoded representation until a corresponding comprehensive latent space neural encoded representation is formed;
processing the corresponding comprehensive latent space neural encoded representation through an image decoder; and
generating, in an image format, the complete image of the first image.

2. The method of claim 1, wherein the training the MHN using the one or more image datasets comprises:
processing the one or more image datasets through the image encoder to transform each of the one or more image datasets into comprehensive latent space neural encoded representations; and
storing each of the comprehensive latent space neural encoded representations within the MHN to generate the MHN.

3. The method of claim 1, wherein the HEN comprises:
a pre-trained autoencoder neural network, wherein the pre-trained autoencoder neural network comprises the image encoder paired to the image decoder.

4. The method of claim 2, wherein each of one or more images in the one or more image datasets are stored implicitly within the MHN through their comprehensive latent space representations.

5. The method of claim 1, wherein processing the latent space neural encoded representation through the MHN as the retrieval cue to iteratively update the latent space neural encoded representation until the corresponding comprehensive latent space neural encoded representation is formed comprises the MHN performing a Hopfield network state update procedure utilizing the latent space neural encoded representation.

6. (canceled)

7. The method of claim 5, wherein the MHN converges in sixty iterations or less during the performing of the Hopfield network state update procedure.

8. A computer system for implicit data storage and retrieval using a Hopfield encoding network (HEN), the computer system comprising:
a processor set;
one or more computer-readable storage media; and
program instructions stored on the one or more computer-readable storage media to cause the processor set to perform operations comprising:
training a Modern Hopfield network (MHN) within the HEN using one or more image datasets;
receiving a partial query for a complete image of a first image, wherein the partial query includes the first image displaying fifty percent or less of the complete image;
processing the partial query through an image encoder to transform the partial query into a latent space neural encoded representation;
processing the latent space neural encoded representation through the MHN as a retrieval cue to iteratively update the latent space neural encoded representation until a corresponding comprehensive latent space neural encoded representation is formed;
processing the corresponding comprehensive latent space neural encoded representation through an image decoder; and
generating, in an image format, the complete image of the first image.

9. The computer system of claim 8, wherein the training the MHN using the one or more image datasets comprises:
processing the one or more image datasets through the image encoder to transform each of the one or more image datasets into comprehensive latent space neural encoded representations; and
storing each of the comprehensive latent space neural encoded representations within the MHN to generate the MHN.

10. The computer system of claim 8, wherein the HEN comprises:
a pre-trained autoencoder neural network, wherein the pre-trained autoencoder neural network comprises the image encoder paired to the image decoder.

11. The computer system of claim 9, wherein each of one or more images in the one or more image datasets are stored implicitly within the MHN through their comprehensive latent space representations.

12. The computer system of claim 8, wherein processing the latent space neural encoded representation through the MHN as the retrieval cue to iteratively update the latent space neural encoded representation until the corresponding comprehensive latent space neural encoded representation is formed comprises the MHN performing a Hopfield network state update procedure utilizing the latent space neural encoded representation.

13. (canceled)

14. The computer system of claim 12, wherein the MHN converges in sixty iterations or less during the performing of the Hopfield network state update procedure.

15. A computer program product for implicit data storage and retrieval using a Hopfield encoding network (HEN), the computer program product comprising:
one or more computer-readable storage media; and
program instructions stored on the one or more computer-readable storage media to perform operations comprising:
training a Modern Hopfield network (MHN) within the HEN using one or more image datasets;
receiving a partial query for a complete image of a first image, wherein the partial query includes the first image displaying fifty percent or less of the complete image;
processing the partial query through an image encoder to transform the partial query into a latent space neural encoded representation;
processing the latent space neural encoded representation through the MHN as a retrieval cue to iteratively update the latent space neural encoded representation until a corresponding comprehensive latent space neural encoded representation is formed;
processing the corresponding comprehensive latent space neural encoded representation through an image decoder; and
generating, in an image format, the complete image of the first image.

16. The computer program product of claim 15, wherein the training the MHN using the one or more image datasets comprises:
processing the one or more image datasets through the image encoder to transform each of the one or more image datasets into comprehensive latent space neural encoded representations; and
storing each of the comprehensive latent space neural encoded representations within the MHN to generate the MHN.

17. The computer program product of claim 15, wherein the HEN comprises:
a pre-trained autoencoder neural network, wherein the pre-trained autoencoder neural network comprises the image encoder paired to the image decoder.

18. The computer program product of claim 16, wherein each of one or more images in the one or more image datasets are stored implicitly within the MHN through their comprehensive latent space representations.

19. The computer program product of claim 15, wherein processing the latent space neural encoded representation through the MHN as the retrieval cue to iteratively update the latent space neural encoded representation until the corresponding comprehensive latent space neural encoded representation is formed comprises the MHN performing a Hopfield network state update procedure utilizing the latent space neural encoded representation.

20. (canceled)

21. The computer program product of claim 19, wherein the MHN converges in sixty iterations or less during the performing of the Hopfield network state update procedure.
